(19) United States
(12) Patent Application Publication
(10) Pub. No.: US 2006/0137620 A1
(43) Pub. Date: Jun. 29, 2006

(54) Waste-containment enhancement device for simple litter pans

(76) Inventor: E. Thomas Joy, Blacksburg, VA (US)

Correspondence Address: E. Thomas Joy, 1156 Hightop Road, Lot 189, Blacksburg, VA, 24060, US

(21) Appl. No.: 11/023,608

(22) Filed: Dec. 29, 2004

(51) Int. Cl. A01K 1/035

(52) U.S. Cl. 119/165

(57) ABSTRACT

A device that can be installed on a simple litter pan to enhance the capability of the litter pan to retain pet wastes that, in the absence of the device, might be voided by the pet over the side of the pan. The invention provides a sloping surface around the rim of the litter pan to intercept urine and feces and redirect them to the litter within the pan. It may be removably attached to the litter pan at the option of the user.

### BACKGROUND OF THE INVENTION

This invention relates to a device that when installed on a simple litter pan, reduces the possibility that wastes voided by a pet standing within the litter pan might fall outside the pan to contaminate the surrounding area. The invention provides an inclined surface around the litter pan's rim. This surface intercepts wastes voided by the pt, which in the absence of the invention might have been voided over the rim to fall outside the pan, and redirects them to litter contained within the litter pan.

Most commonly available litter pans, also known as litter boxes, are simple, open-top containers with low, nearly vertical sides that hold a layer of granular absorbent material called “litter” to provide a toilet facility for pets. To use such a simple litter pan, the animal merely steps over a side to stand on the litter. Problems arise when the animal fails to move far enough toward the center of the pan. In such a case, it may void over the low side of the simple litter pan to contaminate the adjacent area. This invention, when mounted on the rim of a simple litter pan, decreases that possibility by enhancing the waste-retaining capability of the pan in several ways:
1. Because the upper edge of the invention extends outside and above the rim of the simple litter pan, the effect of the invention is to enlarge litter pan's perimeter while at the same time increasing the height of its rim.
2. The projection of the lower edge of the invention into the litter pan opening (in some embodiments) forces the animal to move further away from the extended rim toward the center of the litter pan.
3. Wastes that are intercepted by the inclined surface of the invention are redirected downward and inward to the litter on the bottom of the pan.

A search of United States Patent Office records revealed no other patent describing an invention comparable to this invention.

### BRIEF SUMMARY OF THE INVENTION

The invention is intended to be installed on a simple litter pan to enhance the ability of the pan to retain wastes voided by a pet using the pan. It comprises a device for intercepting wastes and redirecting them to the litter within the pan, and an optional means for removably attaching the device to the litter pan.

It is an object of the invention to provide a waste-containment enhancement device for simple litter pans that will lessen the possibility that bodily wastes voided by a pet standing within a litter pan might fall outside the litter pan to contaminate the surrounding area.

It is a second object of the invention to provide a waste-containment enhancement device for simple litter pans which will redirect wastes that contact the invention to the litter within the litter pan.

It is a third object of the invention to provide a waste-containment enhancement device for simple litter pans that can be removably attached to a simple litter pan.

### BRIEF DESCRIPTION OF THE SEVERAL VIEWS OF THE DRAWINGS

FIG. 1 is a plan view of an embodiment of the Waste-Containment Enhancement Device for Simple Litter Pans mounted on a simple litter pan.

FIG. 2 is a sectional view along section I-I of FIG. 1.

FIG. 3 is a plan view of embodiment of the Waste-Containment Enhancement Device for Simple Litter Pans removably attached to a simple litter pan.

FIG. 4 is a sectional view along section I-I of FIG. 3.

### DETAILED DESCRIPTION OF THE INVENTION

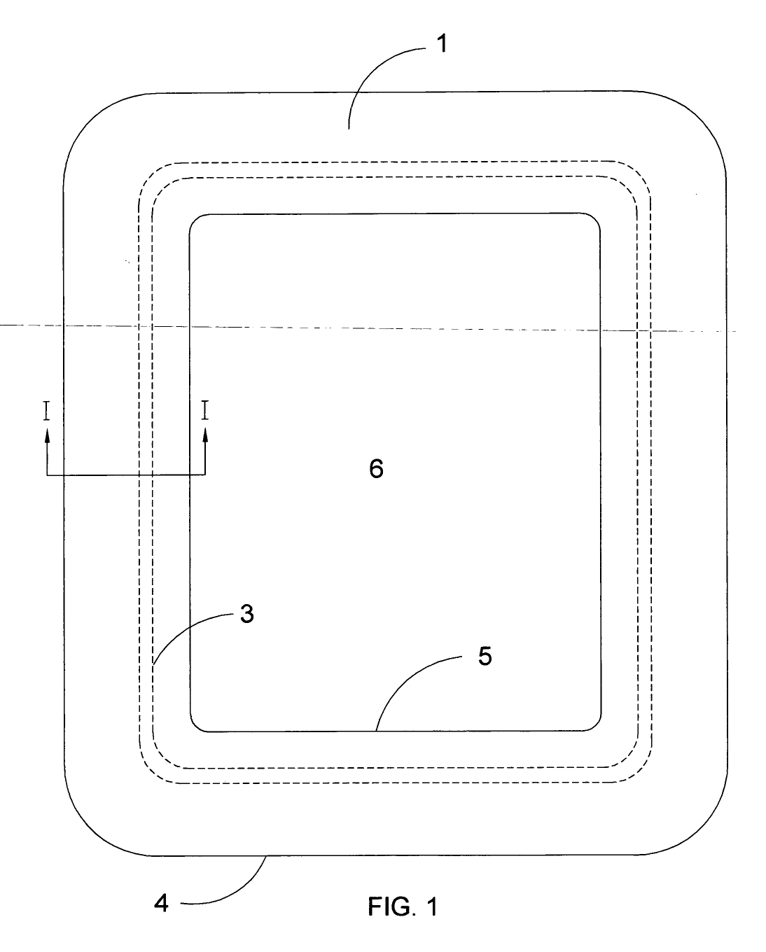

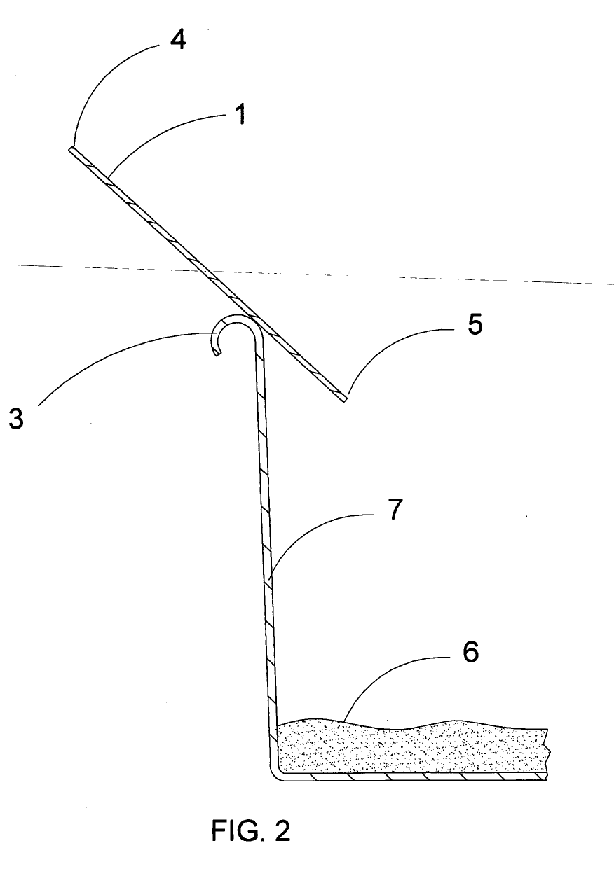

Referring to FIGS. 1 and 2, an embodiment of the invention having straight sides 1 in cross-sectional profile is shown mounted on the rim 3 of a simple litter pan. The invention's sides 1 provide a continuous, inclined surface around the rim 3 of the litter pan. This inclined surface is positioned to intercept pet wastes and redirect them to the litter 6 within the pan. Because the upper edge 4 of the invention extends outside and above the rim 3 of the litter pan, the effect of the invention is to enlarge the litter pan's perimeter while at the same time increasing its height. The projection of the invention's lower edge 5 into the opening of the litter pan not only forces a pet toward the center of the litter pan and away from the invention's upper edge 4, thus lessening the possibility that the pet's wastes might pass over the upper edge 4 to fall outside the pan, but it also forms a “drip lip” that prevents redirected wastes from contacting the sides 7 of the litter pan. The inclination of the invention's sides 1 redirects wastes intercepted by the invention's surface downward and inward toward the litter 6 contained in the pan. In this embodiment, a side 1 of the invention is depicted as being straight in cross-sectional profile and inclined at an angle of approximately 45 degrees from the horizontal. However, this invention relates to any combination of inclination and cross-sectional shape of the sides 1 that allows the interception of pet wastes and their redirection to pet litter 6 within the pan.

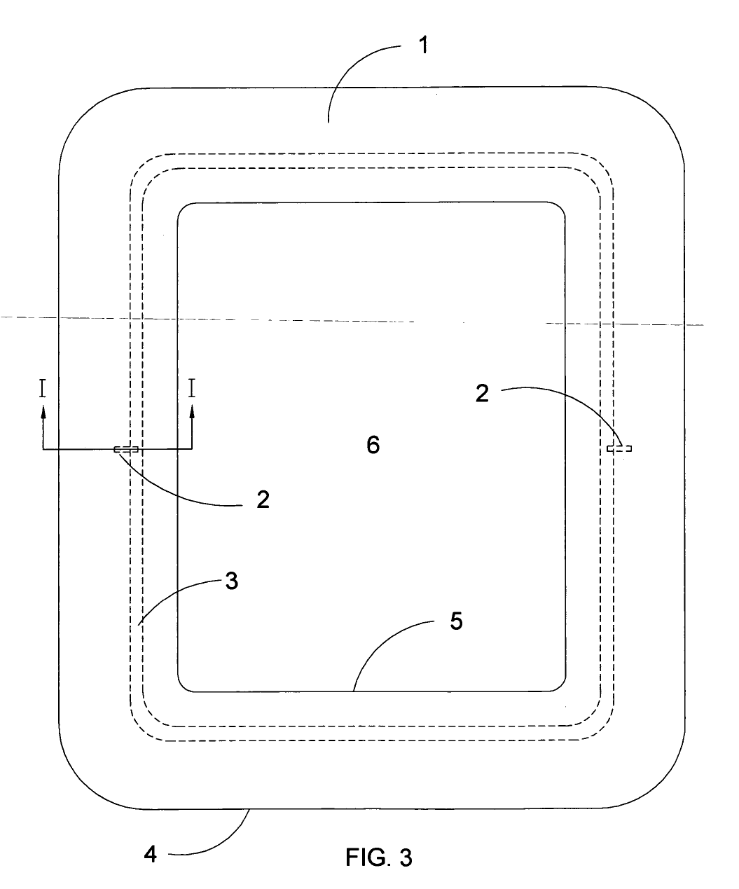

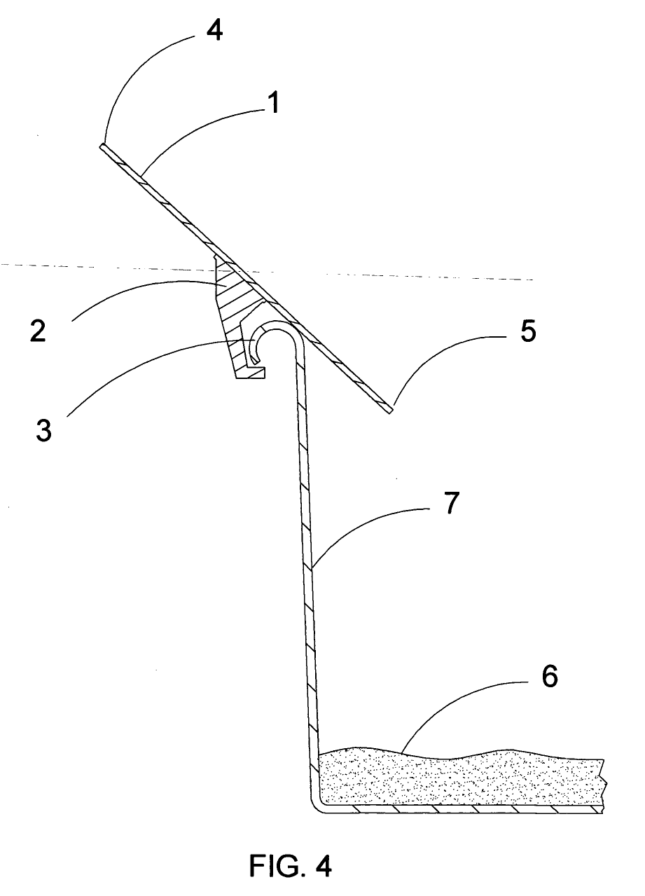

Referring to FIGS. 3 and 4, it is contemplated that in use, the invention could, at the option of the purchaser, be removably attached to the litter pan by the use of some means for removable attachment 2. This invention contemplates that the means for removable attachment 2 might comprise members that would either be manufactured separately and supplied in a separate packet at purchase or permanently attached to the invention at manufacture.

If the members of the means for removable attachment 2 were packaged separately, the purchaser could, if desired, affix them to the exterior of the invention by any method that might be provided, such as glue or tape, prior to mounting the invention on the litter pan. In this embodiment, the members of the means for removable attachment 2 are shown as hooks with proximal ends attached by any practicable means to the exterior of the invention, and with distal ends capable of being hooked beneath the edge of the litter pan's rim 3. However, if the members were of some other type, tape strips, for example, it might be more practical for the distal ends to attach to the exteriors of the litter pan sides 7 rather than to the rim 3.

If the members of the means for removable attachment 2 were to be permanently attached to the invention at manufacture, they should be structured so as to allow them to fold against the exterior of the invention to facilitate stacking of the invention during shipment and storage.

I claim:

1. A new removable device for increasing the ability of a simple rectangular litter pan to retain wastes, which without the device might have been voided over the side of the pan by a pet within the pan, by intercepting and redirecting the wastes to the litter within the pan, which device comprises an intercepting and redirecting means open at the top and bottom having four inclined sides joined at the corners, constructed of deformable polymer material of the approximate thickness of the litter pan material, exhibiting approximately the same length ratios as the lengths of the sides of the litter pan rim, and sloping smoothly inward from top to bottom such that when the intercepting and redirecting means is mounted on the litter pan, its upper margin, which may incorporate a stiffening means such as a circumferential flange or thickened area, delineates an opening outside and above the rim of the litter pan and its lower margin from which intercepted and redirected wastes drip or fall to the litter within the pan, delineates an opening inside and below the rim of the litter pan, the outer surface of which device rests on and more or less continuously contacts the interior edge of the litter pan rim which supports the device along the line of intersection of an imaginary plane horizontally intersecting the device's inclined sides and containing the rim of the litter pan.

2. (canceled)

3. (canceled)
